(19) United States
(12) Patent Application Publication
(10) Pub. No.: US 2010/0302266 A1
(43) Pub. Date: Dec. 2, 2010

(54) INTEGRATED CIRCUIT APPARATUS, ELECTRO-OPTICAL APPARATUS, AND ELECTRONIC EQUIPMENT

(75) Inventor: Akira MORITA, Shimosuwa-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/726,872

(22) Filed: Mar. 18, 2010

(30) Foreign Application Priority Data
Jun. 2, 2009 (JP) 2009-133082

(51) Int. Cl. G09G 5/36

(52) U.S. Cl. 345/559

(57) ABSTRACT

An integrated circuit apparatus includes data-line drive circuits, an offset register that stores offset set values corresponding to a plurality of pixels, and correction circuits that perform processing of correcting the offsets on the basis of the offset set values. The offset register stores offset set values for the positive polarity and offset set values for the negative polarity. The data-line drive circuits supply data signals resulting from correction based on the offset set values for the positive polarity in a positive drive period and supply data signals resulting from correction based on the offset set values for the negative polarity in a negative drive period.

This application is based on and claims priority to Japanese Patent Application No. 2009-133082, filed on Jun. 2, 2009, the contents of which are herein incorporated by reference.

### TECHNICAL FIELD

An aspect of the present invention relates to integrated circuit apparatus, electro-optical apparatus, electronic equipment.

### BACKGROUND ART

In recent years, high-definition video technologies such as high-definition video have been widely spread. The number of resolutions and the number of gray scales have increased in displays such as liquid crystal projectors. With the increases of the numbers of resolutions and gray scales, only small errors occurring in data voltages may disadvantageously cause display unevenness because as the number of gray-scales increases, the gray-scale voltage per gray scale decreases.

The present applicant has developed a driver based on a multiplex drive scheme in which each data-line drive circuit writes a data voltage to a plurality of pixels in one horizontal scanning period. However, the driver based on the scheme has a problem that a plurality of multiplex-driven data voltages have offsets. Errors due to the offsets may cause display unevenness (stripes) in a display image.

Patent Document 1 discloses a method that averages errors in data voltages by switching the sequence of driving a plurality of data lines subject to multiplex drive. Patent Document 2 discloses a method that divides a screen into areas at predetermined intervals and corrects color unevenness in the areas.

### [Citation List]

### [Patent Documents]

[Patent Document 1] JP-A-2004-45967

[Patent Document 2] JP-A-2002-108298

### SUMMARY OF THE INVENTION

### Problems that the Invention is to Solve

According to several aspects of the invention, an integrated circuit apparatus, electro-optical apparatus and electronic equipment that may prevent display unevenness can be provided.

### Means for Solving the Problems

An aspect of the invention relates to an integrated circuit apparatus including data-line drive circuits that are provided in association with a plurality of data signal supply lines and each of which supplies a multiplexed data signal to the corresponding data signal supply line of the plurality of data signal supply lines, an offset register that stores offset set values corresponding to offsets occurring in a plurality of demultiplexed data signals resulting from demultiplexing by a demultiplexer on the multiplexed data signal when the plurality of data signals are supplied to a plurality of pixels in one horizontal scanning period, and correction circuits that are provided in association with the data-line drive circuits and perform processing of correcting the offsets on the basis of the offset set values, wherein the offset register stores offset set values for the positive polarity and offset set values for the negative polarity as the offset set values and the data-line drive circuits supply data signals resulting from correction based on the offset set values for the positive polarity to the data signal supply lines in a positive drive period and supply data signals resulting from correction based on the offset set values for the negative polarity to the data signal supply lines in a negative drive period.

According to the aspect of the invention, offset set values for the positive polarity and offset set values for the negative polarity are stored. In a positive drive period, processing of correcting offsets in data signals is performed on the basis of the offset set values for the positive polarity. The data signals after the correction processing are supplied to the data signal supply lines. In a negative drive period, processing of correcting offsets in data signals is performed on the basis of the offset set values for the negative polarity. The data signals after the correction processing are supplied to the data signal supply lines. The data signals supplied to the data signal supply lines are demultiplexed and are supplied to a plurality of pixels in one horizontal scanning period.

Thus, even when the offsets occurring in the plurality of data signals after the demultiplexing are different between a positive drive period and a negative drive period, the offsets in the data signals can be corrected.

In the aspect of the invention, the data-line drive circuits may include drive circuits for odd-ordered data lines that supply data signals to data signal supply lines for odd-ordered pixels of the plurality of pixels, and drive circuits for even-ordered data lines that supply data signals to data signal supply lines for even-ordered pixels of the plurality of pixels, and the offset register may include an offset register for odd-ordered pixels that stores an offset set value for odd-ordered pixels corresponding to an offset occurring in data signals to be supplied to the odd-ordered pixels, and an offset register for even-ordered pixels that stores an offset set value for even-ordered pixels corresponding to an offset occurring in data signals to be supplied to the even-ordered pixels.

Thus, offset set values for even-ordered pixels and offset set values for the negative polarity are stored. The data signals corrected on the basis of the offset set values for odd-ordered pixels are supplied to the odd-ordered pixels. The data signals corrected on the basis of the offset set values for even-ordered pixels are supplied to the even-ordered pixels. Therefore, even when the offsets occurring in data signals for odd-ordered pixels and even-ordered pixels are different, the offsets in the data signals may be corrected.

In the aspect of the invention, the offset register for odd-ordered pixels may store an offset set value for odd-ordered pixels for the positive polarity and an offset set value for odd-ordered pixels for the negative polarity as the offset set value for odd-ordered pixels, and the offset register for even-ordered pixels may store an offset set value for even-ordered pixels for the positive polarity and an offset set value for even-ordered pixels for the negative polarity as the offset set value for even-ordered pixels, and the drive circuits for odd-ordered data lines may supply the data signals resulting from the correction based on the offset set value for odd-ordered pixels for the positive polarity to the data signal supply lines for odd-ordered pixels in a positive drive period and supply the data signals resulting from the correction based on the offset set value for odd-ordered pixels for the negative polarity to the data signal supply lines for odd-ordered pixels in a negative drive period, and the drive circuits for even-ordered data lines supply the data signals resulting from the correction based on the offset set value for even-ordered pixels for the positive polarity to the data signal supply lines for even-ordered pixels in a positive drive period, and supply the data signals resulting from the correction based on the offset set value for even-ordered pixels for the negative polarity to the data signal supply lines for even-ordered pixels in a negative drive period.

Thus, even when offsets occurring in data signals for odd-ordered and even-ordered pixels are different between positive drive periods and negative drive periods, the offsets in the data signals may be corrected.

In the aspect of the invention, the integrated circuit apparatus may further include a data distribution circuit that supplies data to the data-line drive circuits. In this case the data-line drive circuits may have latch circuits for odd-ordered data lines provided in association with the drive circuits for odd-ordered data lines, and latch circuits for even-ordered data lines provided in association with the drive circuits for even-ordered data lines. The data distribution circuit may receive image data input in a time series manner, supply the equal number of image data for odd-ordered data lines to the number of multiplexing points to the latch circuits for odd-ordered data lines and supply the equal number of image data for even-ordered data lines to the number of multiplexing points to the latch circuits for even-ordered data lines.

Thus, data can be distributed through the data distribution circuit. In other words, the equal number of image data for odd-ordered data lines to the number of multiplexing points may be supplied to the odd-ordered data-line drive circuits. The equal number of image data for even-ordered data lines to the number of multiplexing points may be supplied to the even-ordered data-line drive circuits.

In the aspect of the invention, the offset registers may at least store, as the offset set values, a first offset set value corresponding to the first pixel of the first to pth (where p is an integer that is equal to or greater than two) pixels of the plurality of pixels and a pth offset set value corresponding to the pth pixel of the first to pth pixels. The correction circuit may at least perform, as the processing of correcting the offsets, processing of adding an offset correction value based on the first offset set value to the first image data of the first to pth image data corresponding to the first to pth pixels and processing of adding an offset correction value based on the pth offset set value to the pth image data of the first to pth image data.

Thus, the first and pth offset set values corresponding to at least the first and pth pixels may be stored. On the basis of the first and pth offset set values, the offsets occurring in the data signals at least the first and pth pixels may be corrected.

In the aspect of the invention, the offset register may store the second to (p−1)th offset set values corresponding to the second to (p−1)th pixels of the first to pth pixels. The correction circuit may perform processing of adding offset correction values based on the second to (p−1)th offset set values to the second to (p−1)th image data of the first to pth image data.

Thus, the second to (p−1)th offset set values corresponding to the second to (p−1)th pixels may be stored. On the basis of the second to (p−1)th offset set values, the offset occurring in the data signals for the second to (p−1)th pixels may be corrected.

In the aspect of the invention, the integrated circuit apparatus may further include a switch signal generation circuit that generates demultiplexing switch signals for controlling the ON- and OFF-states of a plurality of demultiplexing switching elements included in the demultiplexer.

Thus, the ON- and OFF-states of switching elements for a plurality of demultiplex points included in the demultiplexer may be controlled. Therefore, multiplexed data signals may be demultiplexed by the demultiplexer.

Another aspect of the invention relates to an electro-optical apparatus including the integrated circuit apparatus.

Another aspect of the invention relates to electronic equipment including the electro-optical apparatus.

### BRIEF DESCRIPTION OF DRAWINGS

FIG. 1 illustrates a configuration example of an electro-optical apparatus.

FIG. 2 is an explanatory diagram on an operation with multiplex drive.

FIG. 3 is an explanatory diagram on an operation with multiplex drive.

FIG. 4 is an explanatory diagram on position offset voltages.

FIG. 5 is an explanatory diagram on position offset voltages.

FIG. 6 is an explanatory diagram on position offset voltages in a positive drive period and a negative drive period.

FIG. 7 is a first configuration example of an integrated circuit apparatus of this embodiment.

FIG. 8 is an explanatory diagram on an operation in the first configuration example.

FIG. 9(A) and FIG. 9(B) are explanatory diagrams on distributed drive.

FIG. 10(A) and FIG. 10(B) are explanatory diagrams on an operation with distributed drive.

FIG. 11 is a fundamental configuration example of an integrated circuit apparatus that performs distributed drive.

FIG. 12 is an explanatory diagram on position offset voltages in data voltages for odd-ordered and even-ordered pixels.

FIG. 13 is a second configuration example of an integrated circuit apparatus of this embodiment.

FIG. 14 is a detail configuration example of a data distribution circuit.

FIG. 15 is a detail configuration example of a data driver.

FIG. 16 is a configuration example of electronic equipment.

### MODE FOR CARRYING OUT THE INVENTION

Preferred embodiments of the invention will be described in detail below. The following embodiments do not invalidly limit the spirit and scope of the invention disclosed in the appended claims. All of the configurations according to the embodiments are not typically required as solving means of the invention.

### 1. Configuration Example of Electro-Optical Apparatus

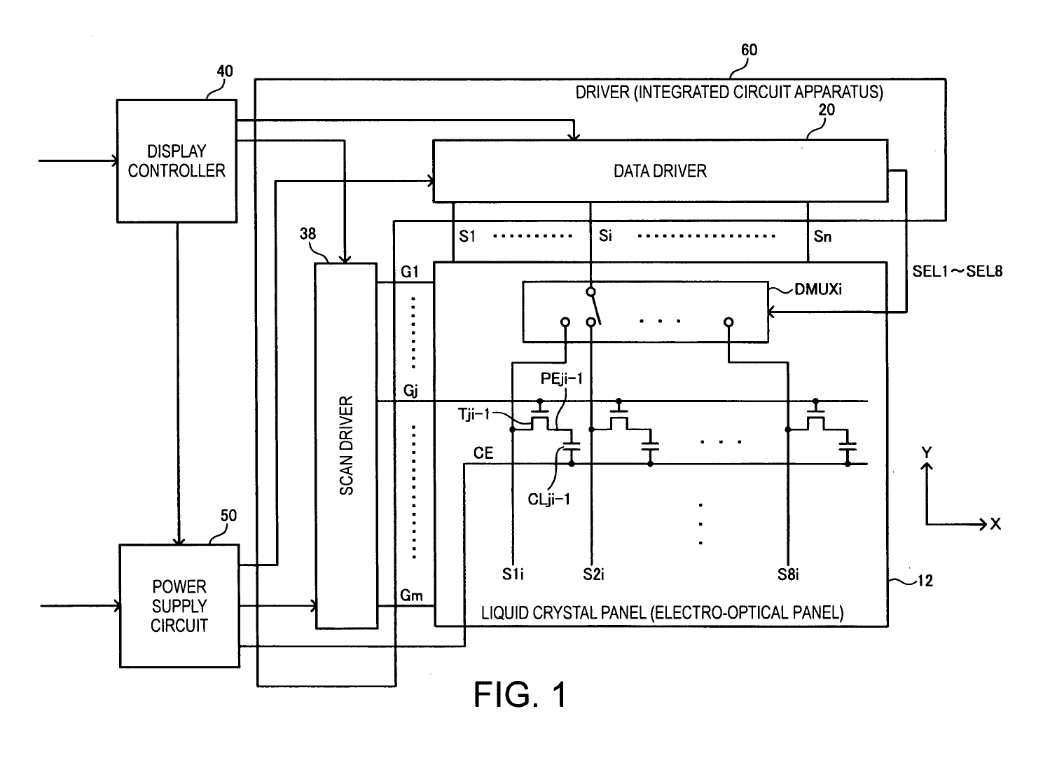

With reference to FIGS. 1 to 3, multiplex drive (line sequential driving) will be described. For example, driving a monochrome liquid crystal panel will be described below. However, according to an embodiment of the invention, a multi color (such as RGB) liquid crystal panel may be driven, or electro-optical panel such as an electro-luminescence (EL) panel and an electrophoretic display (EPD), excluding liquid crystal panels, may be driven. In the following example, data signals to be supplied to data signal supply lines are data voltages. However, according to this embodiment, the data signals to be supplied to data signal supply lines may be data currents.

FIG. 1 illustrates a configuration example of a liquid crystal display device (LCD or, in a broad sense, electro-optical apparatus). The configuration example illustrated in FIG. 1 includes a liquid crystal panel 12 (in a broad sense, electro-optical panel), a driver 60 (integrated circuit apparatus), a display controller 40, and a power supply circuit 50. The electro-optical apparatus of this embodiment is not limited to the configuration in FIG. 1 but may be implemented in different variations including partial omission of the components (such as the display controller) and addition of another component. For example, illustrating a demultiplexer contained in the liquid crystal panel in FIG. 1, the demultiplexer may be included in a data driver 20 according to this embodiment.

On a liquid crystal substrate (such as an active matrix substrate) of the liquid crystal panel 12, scan lines G1 to Gm (which are gate lines where m is a natural number that is equal to or greater than two), data lines S11 to S81, S12 to S82, . . . , and S1n to S8n (which are source lines where n is a natural number that is equal to or greater than two) are arranged. On the liquid crystal substrate, data signal supply lines S1 to Sn (which are data voltage supply lines or data current supply lines) are provided. In association with the respective data signal supply lines Si (where i is a natural number that is equal to or lower than n), a demultiplexer DMUXi is provided. On the liquid crystal substrate, a thin-film transistor Tji-1 is provided at the position corresponding to the intersection of a scan line Gj (where j is a natural number that is equal to or lower than m) and a data line S1i, for example. A liquid crystal capacitance CLji-1 (liquid crystal device or, in a broad sense, electro-optical device) is provided between a pixel electrode PEji-1 and a counter electrode CE (common electrode).

The data signal supply line Si receives a multiplexed (time-division multiplexed) data voltage (or data current or, in a broad sense, data signal). The demultiplexer DMUXi demultiplexes (or separates or divides) the data voltage and supplies the result to data lines. More specifically, the DMUXi includes switching elements (a plurality of switching elements for demultiplexing) in association with the data lines S1i to S8i. In accordance with multiplex control signals SEL1 to SEL8 (switch signals for demultiplexing), the ON and OFF states of the switching elements are controlled.

The driver 60 includes the data driver 20 and a scan driver 38. The data driver 20 outputs the time-divided data voltages to the data signal supply lines S1 to Sn on the basis of image data (gray-scale data). The data driver 20 outputs the SEL1 to SEL8. The scan driver 38 scans (sequentially) the scan lines G1 to Gm in the liquid crystal panel 12.

The display controller 40 may supply, for example, settings for operation modes, vertical synchronizing signals and horizontal synchronizing signals to control the data driver 20, scan driver 38, and power supply circuit 50. The display controller 40 may perform those controls in accordance with the settings by a host controller (such as a CPU), not illustrated. The power supply circuit 50 generates, on the basis of externally supplied reference voltage (power supply voltage), a voltage level (such as a reference voltage for generating gray-scale voltage) required for driving the liquid crystal panel 12 or a voltage level of the counter electrode voltage VCOM (common voltage) of the counter electrode CE.

For easy illustration, FIG. 1 only illustrates the DMUXi corresponding to the Si, the S1i to S8i and the thin-film transistors at the intersections of the S1i to S8i and the Gj. However, the same is true for demultiplexers in association with the other data signal supply lines, data lines and thin-film transistors at the intersections of other data lines and scan lines.

### 2. Operation Example of Multiplex Drive

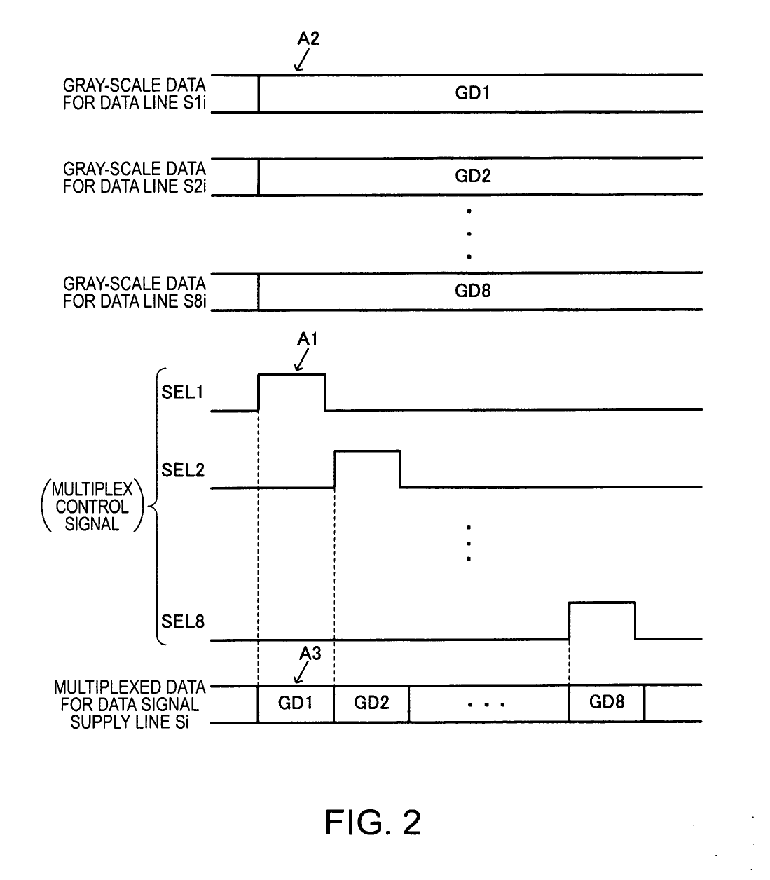

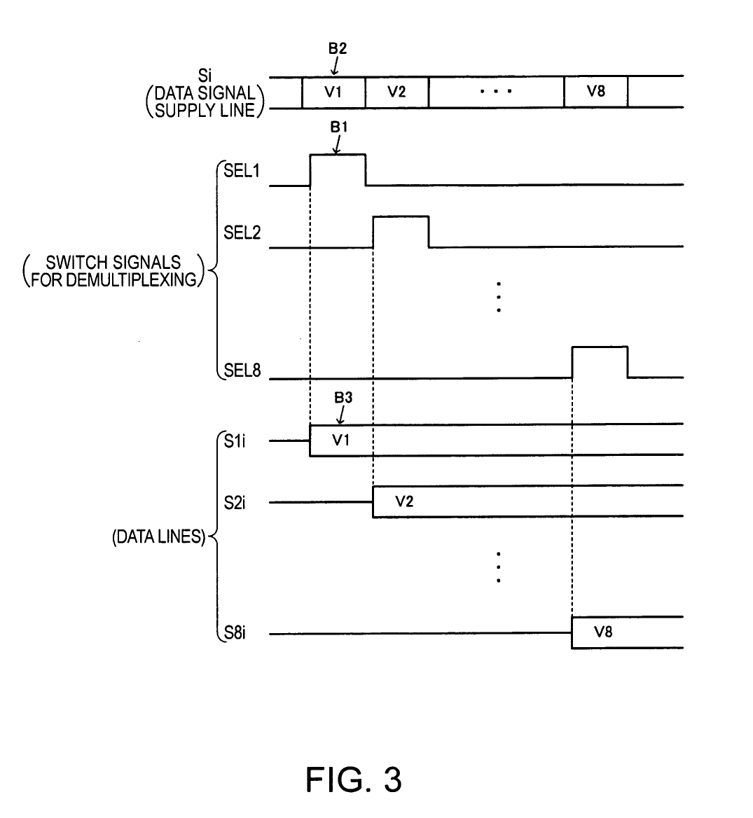

FIGS. 2 and 3 are explanatory diagrams on operations of multiplex drive.

As illustrated in FIG. 2, as image data for the data lines S1i to S8i, image data GD1 to GD8 are latched. As indicated by A1 in FIG. 2, when the multiplex control signal SEL1 becomes active, the image data GD1 indicated by A2 is selected and output as indicated by A3. In the same manner, when the multiplex control signals SEL2 to SEL8 become active, the image data GD2 to GD8 are selected and output. In this way, the time-division multiplexed image data GD1 to GD8 are generated. The time-division multiplexed image data GD1 to GD8 are D/A converted, and the time-division multiplexed data voltages V1 to V8 are generated.

As illustrated in FIG. 3, the time-division multiplexed data voltages V1 to V8 are output to the data signal supply line Si within one horizontal scanning period. As indicated by B1 in FIG. 3, when the multiplex control signal SEL1 is active, the data voltage V1 indicated by B2 is output to the data line S1i as indicated by B3. In the same manner, when the multiplex control signals SEL2 to SEL8 are active, the data voltages V2 to V8 are output to the data lines S2i to S8i. In this way, the time-division multiplexed data voltages V1 to V8 are demultiplexed into the S1i to S8i.

According to this embodiment, the sequence that the signals SEL1 to SEL8 become active may be rotated (or changed) every horizontal scanning period so that the sequence of driving the data lines S1i to S8i is rotated.

### 3. Offset Voltage of Data Voltage

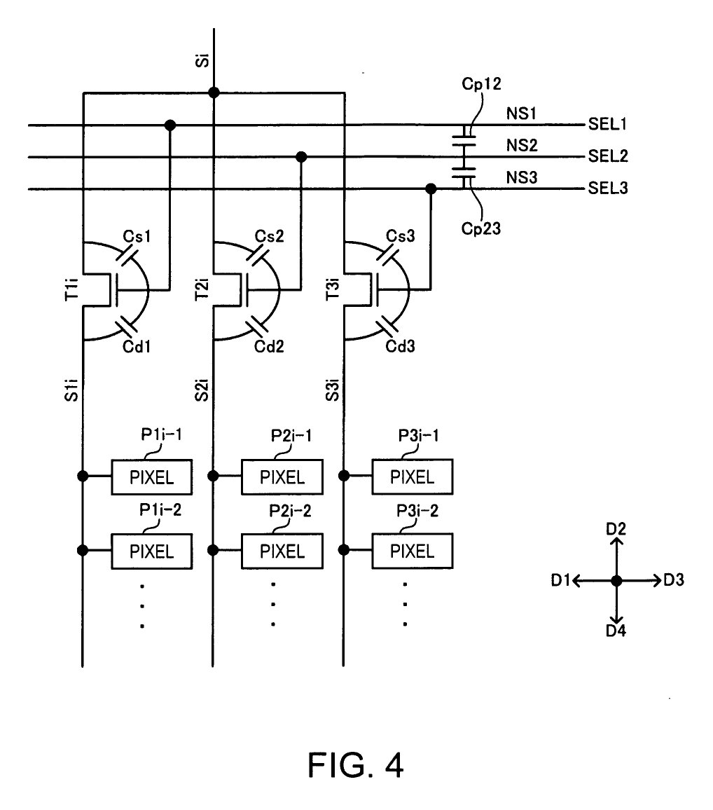

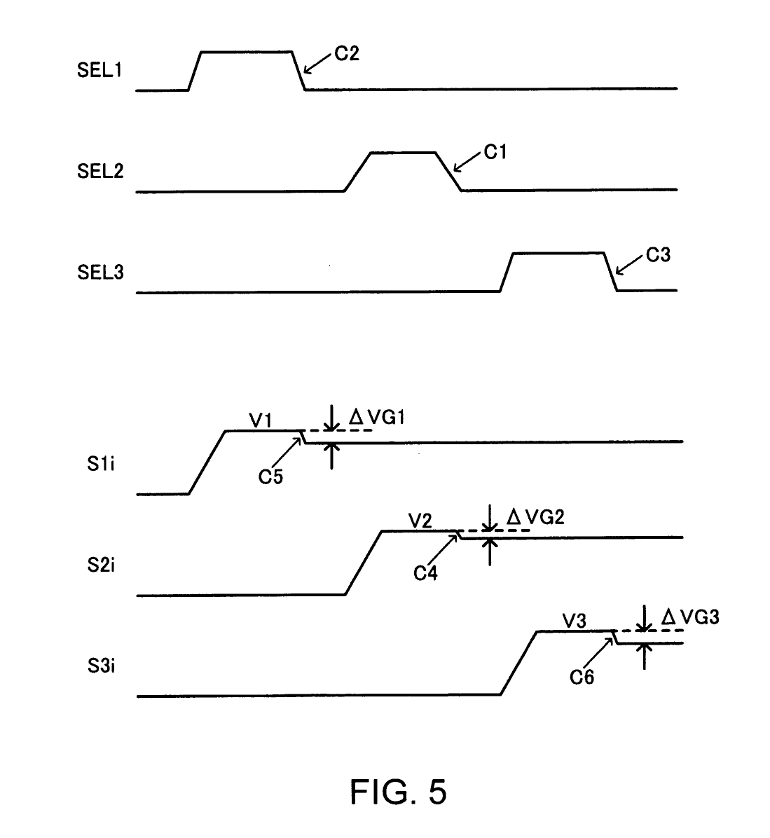

With reference to FIGS. 4 and 5, a concrete example of offset voltages (errors, deviations, variations or, in a broad sense, offset signals) occurring in data voltages will be described. A concrete example in which various position offsets depending on the positions (or alignment order) of data lines in multiplex drive will be described below. However, according to this embodiment, the position offsets may be corrected, or other offsets occurring in data voltages may be corrected.

FIG. 4 schematically illustrates an arrangement example of a liquid crystal panel. Capacitances Cs1 to Cs3, Cd1 to Cd3, Cp12, and Cp23 are parasitic capacitances illustrated schematically and are not components that really exist on the liquid crystal panel. The direction orthogonal to a first direction D1 will be called a second direction D2 hereinafter.

The data lines S1i to S3i are wired along the direction D2 and are sequentially arranged in the direction D1. The S1i to S3i include a plurality of pixels P1i-1 to P3i-1 and P1i-2 to P3i-2. For example, in one horizontal scanning period, the pixels P1i-1 to P3i-1 are multiplex-driven. Between the data lines S1i to S3i and the data signal supply line Si, transistors T1i to T3i (demultiplexers) are provided. The gate electrodes of the T1i to T3i receive multiplex control signals SEL1 to SEL3 through signal lines NS1 to NS3. The NS1 to NS3 are wired along the direction D1 and are sequentially arranged in the direction D2.

Between the NS1 to NS3 and the Si, gate-source capacitances Cs1 to Cs3 occur. Between the NS1 to NS3 and the S1i to S3i, gate-drain capacitances Cd1 to Cd3 occur. Since the NS1 to NS3 run in parallel on the liquid crystal substrate, an inter-wire capacitance Cp12 occurs between the NS1 and the NS2, and an inter-wire capacitance Cp23 occurs between the NS2 and the NS3. Thus, load-carrying capacities Cp12 and Cp23 are in the NS2 at the middle position between the NS1 to NS3. Smaller load-carrying capacities Cp12 and Cp23 are in the NS1 and NS3 positioned at the ends.

Due to the changes in inter-wire capacitance between the NS1 to NS3, the falling edge (changing edge from active to inactive) of the SEL2 indicated by C1 in FIG. 5 changes more slowly than the falling edges of the SEL1 and SEL3 indicated by C2 and C3. When the SEL1 to SEL3 fall, the pushdowns (voltage couplings) through the Cs1 to Cs3 and Cd1 to Cd3 change the voltages in the data lines S1i to S3i. In this case, the amounts of change in voltage due to the pushdown depend on the velocity of the falling edges. The amount of change in voltage ΔVG2 indicated by C4 and the amounts of change in voltage ΔVG1 and ΔVG3 indicated by C5 and C6 are different. In this way, the multiplex-driven data voltage for the pixels has position offsets ΔVG1 to ΔVG3 the amounts of which depend on the positions of the pixels (data lines).

### 4. Offset Voltages in Positive Drive Period and Negative Drive Period

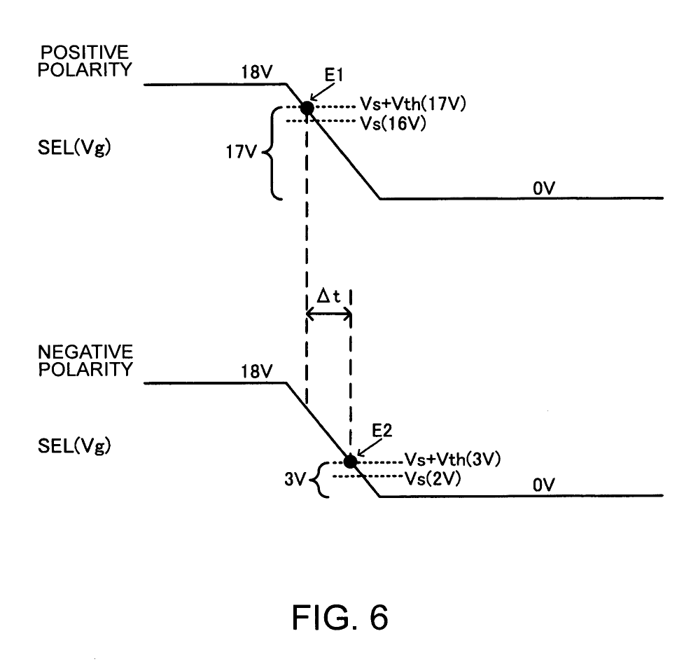

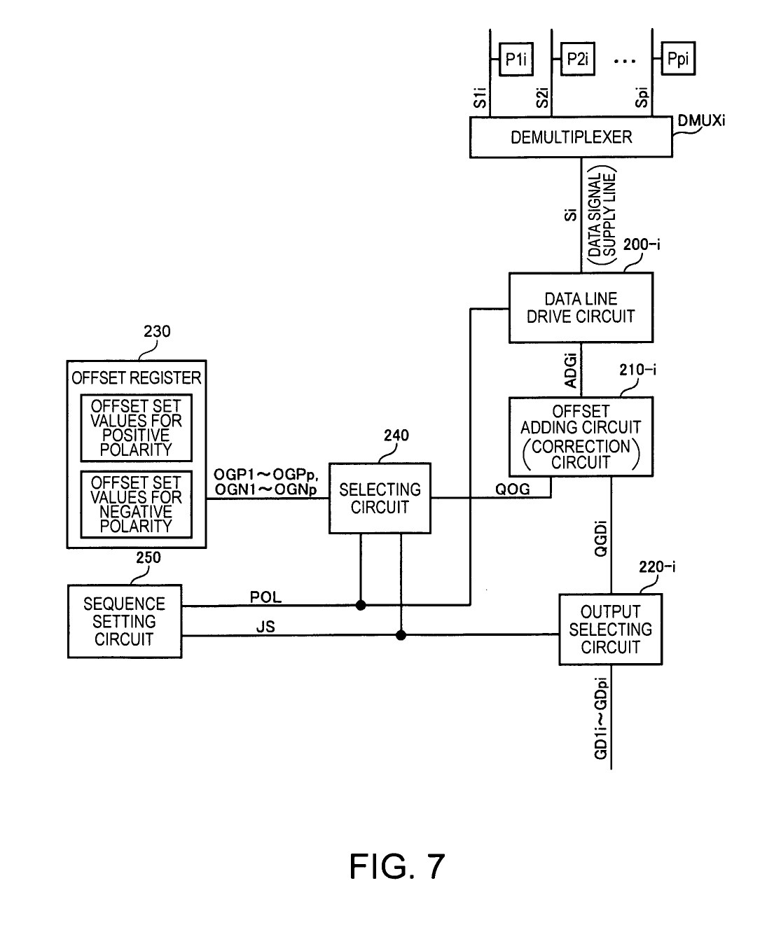

With reference to FIG. 6, position offsets differing between positive drive periods and negative drive periods will be described. Here, a positive drive period is a period when a pixel is driven with a voltage in a data voltage range (16 V to 9 V) that is higher than a counter electrode voltage VCOM (such as 9 V). A negative drive period is a period when a pixel is driven with a voltage in a data voltage range (9 V to 2 V) that is lower than the counter electrode voltage VCOM. Referring to FIG. 7, there will be described a case where a switching element of the demultiplexer is an n-type transistor, for example, will be described.

As indicated by E1 in FIG. 6, it is assumed that a multiplex control signal SEL that is a gate voltage Vg of the transistor is shifted from the active state (18 V) to the inactive state (0 V). In a positive drive period, the voltage of the data line that is a source voltage Vs of the transistor is a higher data voltage (16 V) than the VCOM. Thus, when Vg=Vs+Vth (17 V), the transistor is turned off. On the other hand, as indicated by E2, in a negative drive period, the source voltage Vs is a lower data voltage (2 V) than the VCOM. Thus, when Vg=Vs+Vth (3 V), the transistor is turned off.

In this way, between a positive drive period and a negative drive period, the transistor is turned off in different timings. Therefore, the times for charging data voltages to pixels are different. Since different gate voltages are used to turn off the transistor, the offset voltages due to the pushdown occurring after the transistor is turned off are different. As a result, the position offsets in a positive drive period and a negative drive period are different voltages.

### 5. First Configuration Example

In order to solve the problem, a first configuration example of an integrated circuit apparatus of this embodiment includes first to nth (where n is a natural number that is equal to or greater than two) data-line drive circuits 200-1 to 200-n (a plurality of data-line drive circuits), first to nth offset adding circuits 210-1 to 210-n (in a broad sense, a plurality of correction circuits), first to nth output selecting circuits 220-1 to 220-n (a plurality of output selecting circuits), an offset register 230, a selecting circuit 240, and a sequence setting circuit 250.

FIG. 7 illustrates the ith (where i is a natural number that is equal to or lower than n) data-line drive circuit 200-i, offset adding circuit 210-i (in a broad sense, correction circuit) and output selecting circuit 220-i, and the illustrated components will be described, for example, below. However, the same is also true in the other data-line drive circuits, offset adding circuits, and output selecting circuits. This embodiment is not limited by the first configuration. Different variations of the embodiment may be implemented. For example, part of the components (such as the selecting circuit 240) may be omitted, or other components may be added.

In the first configuration example, a data-line drive circuit performs multiplex drive that writes data voltages to the first to pth pixels P1i to Ppi (where p is a natural number that is equal to or greater than two) in one horizontal scanning period. The data-line drive circuit is a circuit for adding an offset correction value to the image data corresponding to at least the pixels P1i and Ppi to correct an offset in data voltages.

The processing of adding an offset correction value to the first to pth image data GD1i to GDpi corresponding to the pixels P1i to Ppi, which are the image data corresponding to at least the pixels P1i and Ppi, for example, will be described below. However, according to the invention, an offset correction value may be added to the image data GD1i and GDpi as the image data corresponding to at least the pixels P1i and Ppi.

The sequence setting circuit 250 sets the driving sequence of the pixels P1i to Ppi. Then, the sequence setting circuit 250 outputs a pixel select signal JS that instructs a selected one of the pixels P1i to Ppi and a polarity instruction signal POL that instructs either positive drive period or negative drive period. For example, the sequence setting circuit 250 may set the same drive sequence for horizontal scanning periods or may set different drive sequences for horizontal scanning periods for rotation. Line inversion may be performed that inverts the polarity instruction signal between respective horizontal scanning periods, or dot inversion may be performed that inverts the polarity instruction signal between pixels.

The output selecting circuit 220-i receives a pixel select signal JS and image data GD1i to GDpi and outputs selected image data QGDi. The output selecting circuit 220-i performs time-division multiplexing on the GD1i to GDpi on the basis of the JS. More specifically, when receiving the pixel select signal JS instructing the selection of the qth pixel Pqi (where q is a natural number that is equal to or lower than p), the output selecting circuit 220-i selects the image data GDqi and outputs the image data GDqi as the selected image data QGDi.

The offset register 230 stores offset set values OGP1 to OGPp for the positive polarity and offset set values OGN1 to OGNp for the negative polarity. The OGP1 to OGPp are set values corresponding to offset voltages occurring in a positive drive period in data voltages to be written to the pixels P1i to Ppi. The OGN1 to OGNp are set values corresponding to offset voltages occurring in a negative drive period in data voltages to be written to the pixels P1i to Ppi. In the offset register 230, for example, a host controller (CPU), not illustrated, sets the OGP1 to OGPp and OGN1 to OGNp.

The selecting circuit 240 receives the pixel select signal JS, polarity instruction signal POL, offset set values OGP1 to OGPp and OGN1 to OGNp and outputs a selected offset set value QOG. More specifically, when receiving the JS instructing the selection of a pixel Pqi, the selecting circuit 240 selects an offset set value OGPq for the positive polarity in a positive drive period and outputs the OGPq as the QOG. On the other hand, the selecting circuit 240 selects an offset set value OGNq for the negative polarity in a negative drive period and outputs the OGNq as the QOG.

The offset adding circuit 210-i (in a broad sense, correction circuit) performs processing of correcting an offset in a data voltage. More specifically, receiving the selected offset set value QOG and selected image data QGDi, the offset adding circuit 210-i acquires an offset correction value ΔOGi. The offset adding circuit 210-i adds the QGDi and the ΔOGi and outputs the image data ADGi resulting from the addition. According to this embodiment, the QGDi and the ΔOGi may be simply added, or other data may further be added. Alternatively, other data may be multiplied.

Receiving the data ADGi resulting from the offset addition, the data-line drive circuit 200-i outputs the time-division multiplexed data voltage corresponding to the ADGi to the data signal supply line Si. More specifically, the data-line drive circuit 200-i writes the data voltage in a time-division manner to the pixels P1i to Ppi in one horizontal scanning period. For example, the data-line drive circuit 200-i may include a D/A converting circuit that D/A converts the ADGi and generates a time-division multiplexed data voltage and an operational amplifier that outputs the time-division multiplexed data voltage (multiplex data signal) to the Si.

### 6. Operation Example

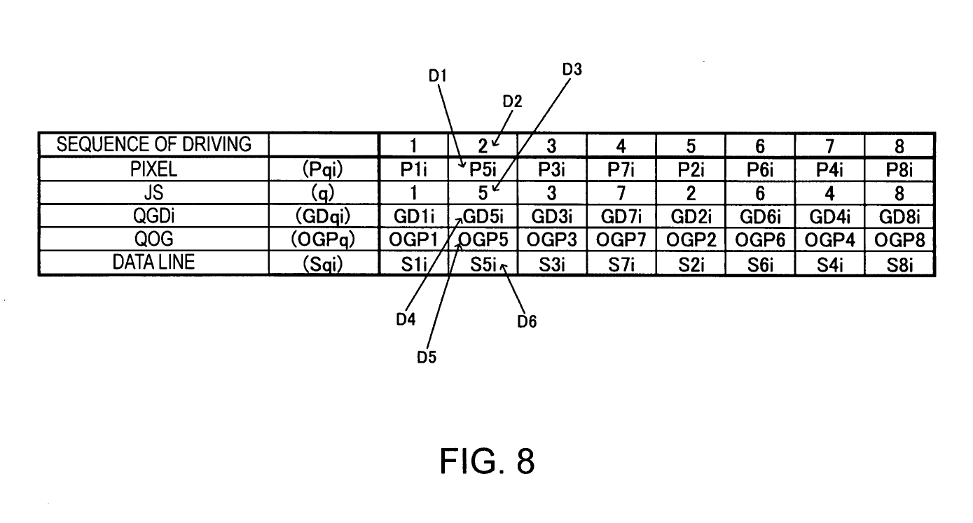

With reference to FIG. 8, an operation example of this embodiment will be described more specifically. FIG. 8 illustrates a case where data voltages are written to the pixels P1i to P8i (p=8) in one horizontal scanning period in a positive drive period. However, the same is true in a negative drive period.

As the drive sequence of the pixels P1i to P8i, the first to 8th pixels to be driven (first to eighth drive periods) in one horizontal scanning period are set. For example, the pixel P5i (where q=5) indicated by D1 in FIG. 8 is set as the second pixel to be driven as indicated by D2. In this case, as indicated by D3, the pixel select signal JS instructing the selection of the pixel P5i is output. On the basis of the JS, as indicated by D4, the image data GD5i is selected, and the selected image data QGDi=GD5i is output. As indicated by D5, the offset set value OGP5 for the positive polarity is selected, and the selected offset set value QOG=OGP5 is output. On the basis of the OGP5 and GD5i, the added image data ADGi are output. On the basis of the ADGi, the data line S5i is driven as indicated by D6.

As described above, there are the problems that offset voltages (position offsets) occur in data voltages in multiplex drive, which causes different offset voltages between positive drive periods and negative drive periods. The offset voltages thus cause errors in the luminance values of the pixels. Therefore, vertical stripes (vertical lines or display unevenness) appear on the display images.

According to this embodiment, the offset register 230 stores offset set values OGP1 to OGPp for the positive polarity and offset set values OGN1 to OGNp for the negative polarity. In a positive drive period, the offset adding circuit 210-i performs processing of correcting offsets on the basis of the offset set values OGP1 to OGPp for the positive polarity. The data-line drive circuit 200-i supplies the data voltage after the correction processing to the data signal supply line Si. On the other hand, in a negative drive period, the offset adding circuit 210-i performs processing of correcting offsets on the basis of the offset set values OGN1 to OGNp for the negative polarity. The data-line drive circuit 200-i supplies the data voltage after the correction processing to the data signal supply line Si.

Thus, offset voltages in data voltages in multiplex drive may be corrected, and the different offset voltages between positive drive periods and negative drive periods may be corrected. More specifically, in a positive drive period, the ΔOGi is acquired on the basis of the OGP1 to OGPp, and the QGDi and the ΔOGi are added. Thus, the offset voltages in the positive drive period may be corrected. In a negative drive period, the ΔOGi is acquired on the basis of the OGN1 to OGNp, and the QGDi and the ΔOGi are added. Thus, the offset voltages in the negative drive period may be corrected. Therefore, the occurrence of vertical stripes on display images may be prevented, which may improve the image quality.

As described with reference to FIG. 5 and so on, offset voltages having different magnitudes occur between the pixels P1i and Ppi at both ends of the pixels P1i to Ppi and the middle pixels P2i to Pp-1i (such as ΔVG1 and ΔVG3 and ΔVG2 in FIG. 5).

According to this embodiment, the offset register 230 may at least store the first and pth offset set values OGP1, OGN1, OGPp, and OGNp corresponding to the pixels P1i and Ppi. The offset adding circuit 210-i may at least perform the processing of adding the offset correction value ΔOGi based on the OGP1 and OGN1 to the image data GD1i and the processing of adding the offset correction value ΔOGi based on the OGPp and OGNp to the image data GDpi.

Thus, the offset correction value ΔOGi corresponding to the pixels P1i and Ppi at both ends may be acquired, and by using the ΔOGi, the data voltages for the pixels P1i and Ppi at both ends may be corrected. This can eliminate the difference in the offset voltages of the data voltages for the pixels P1i and Ppi at both ends and middle pixels P2i to Pp-1i. As a result, the offset voltages of the data voltages for the pixels P1i to Ppi can be corrected.

According to this embodiment, the offset register 230 may further store the second to (p−1)th offset set values OGP2 to OGPp-1 and OGN2 to OGNp-1. The offset adding circuit 210-i may acquire the ΔOGi on the basis of the OGP2 to OGPp-1, OGN2 to OGNp-1 and adds the ΔOGi to the image data GD2i to GDp-1i.

Thus, the acquired offset correction value ΔOGi corresponding to the pixels P1i to Ppi may be used to correct offset voltages of data voltages to the pixels P1i to Ppi. Therefore, offset voltages under various conditions can be properly corrected.

According to this embodiment, the offset register 230 may at least store the first and pth offset constant values OGL1 and OGLp (first and pth offset constant value for the positive polarity and first and pth offset constant values for the negative polarity) as the offset set values. The offset adding circuit 210-i may at least perform processing of adding the OGL1 and OGLp as the ΔOGi (=OGL1 and OGLp) to the image data GD1 and GDp.

According to this embodiment, the offset register 230 may store at least offset coefficient values OGM1 and OGMp (first and pth offset coefficient values for the positive polarity and first and pth offset constant values for the negative polarity) as the offset set values. The offset adding circuit 210-i may at least perform processing of adding the values resulting from the multiplication of the OGM1 and OGMp and the GD1 and GDp as the ΔOGi's (=OGM1×GD1i and OGMp×GDpi) to the image data GD1 and GDp.

Thus, the offset correction values ΔOGi may be acquired on the basis of the offset set values. Acquiring the values resulting from the multiplication of the OGM1 and OGMp and the GD1 and GDp as the ΔOGi's allows correcting inclination of characteristics of position offsets if the characteristics of position offsets have inclination to gray scales of image data.

### 7. Distributed Drive

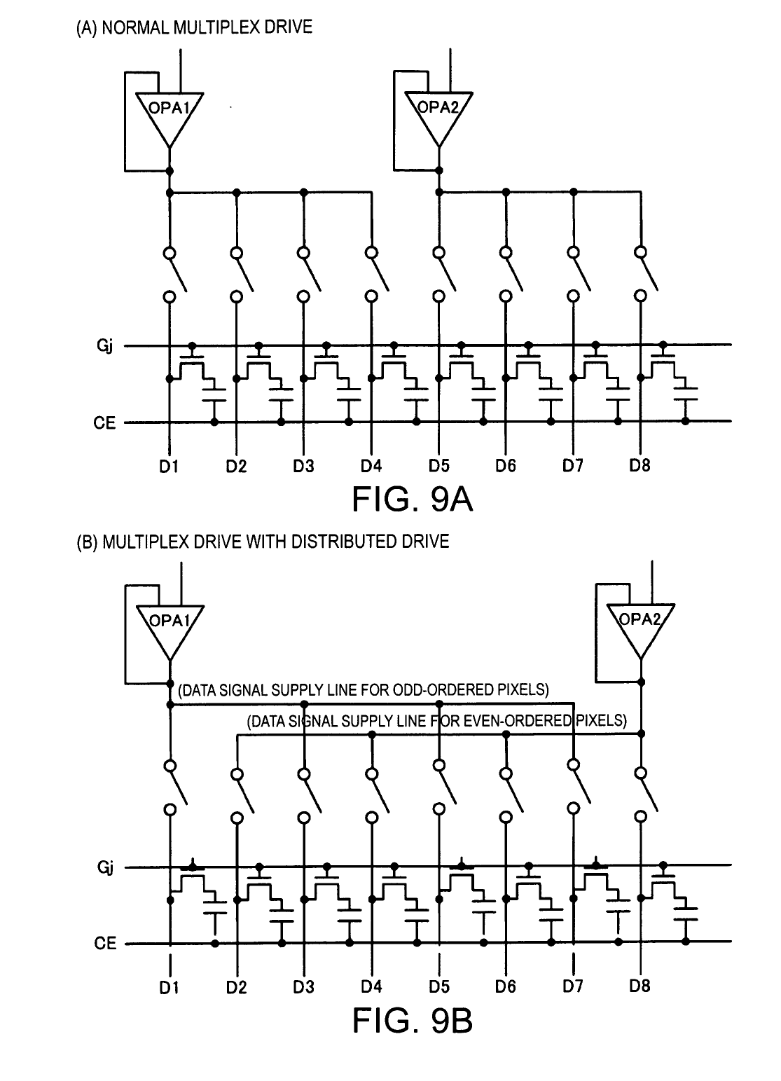

With reference to FIG. 9(A) and FIG. 9(B), distributed drive will be described. FIG. 9(A) and FIG. 9(B) only illustrate part of a liquid crystal panel for the following description. An example using a number of multiplexing points (the number of pixels to be driven in one horizontal scanning period by one data-line drive circuit) of 4 will be described below, but any other number of multiplexing points may be used.

FIG. 9(A) illustrates an explanatory diagram on normal multiplex drive. In normal multiplex drive, the operational amplifier OPA1 sequentially drives data lines D1 to D4 with multiplex control signals SEL1 to SEL4. Similarly, the operational amplifier OPA2 sequentially drives data lines D5 to D8.

FIG. 9(B) illustrates an explanatory diagram on multiplex drive that performs distributed drive. In multiplex drive with distributed drive, the OPA1 sequentially drives (multiplex drives) the odd-ordered data lines D1, D3, D5, and D7 (odd-ordered pixels) with the SEL1 to SEL4. The OPA2 sequentially drives the even-ordered data lines D2, D4, D6, and D8 (even-ordered pixels) with the SEL1 to SEL4. In this way, in distributed drive, neighboring data lines are driven by different operational amplifiers.

Here, the operational amplifiers OPA1 and OPA2 may be connected in a voltage-follower configuration, for example. Since these operational amplifiers generally have offset voltages (input-referred offset voltages), the operational amplifiers output voltages having errors corresponding to the offset voltages. For that reason, the difference in offset voltage between the operational amplifiers may possibly cause display unevenness (such as vertical stripes and band irregularities) on the display images. According to this embodiment, the display unevenness may be prevented by performing the distributed drive.

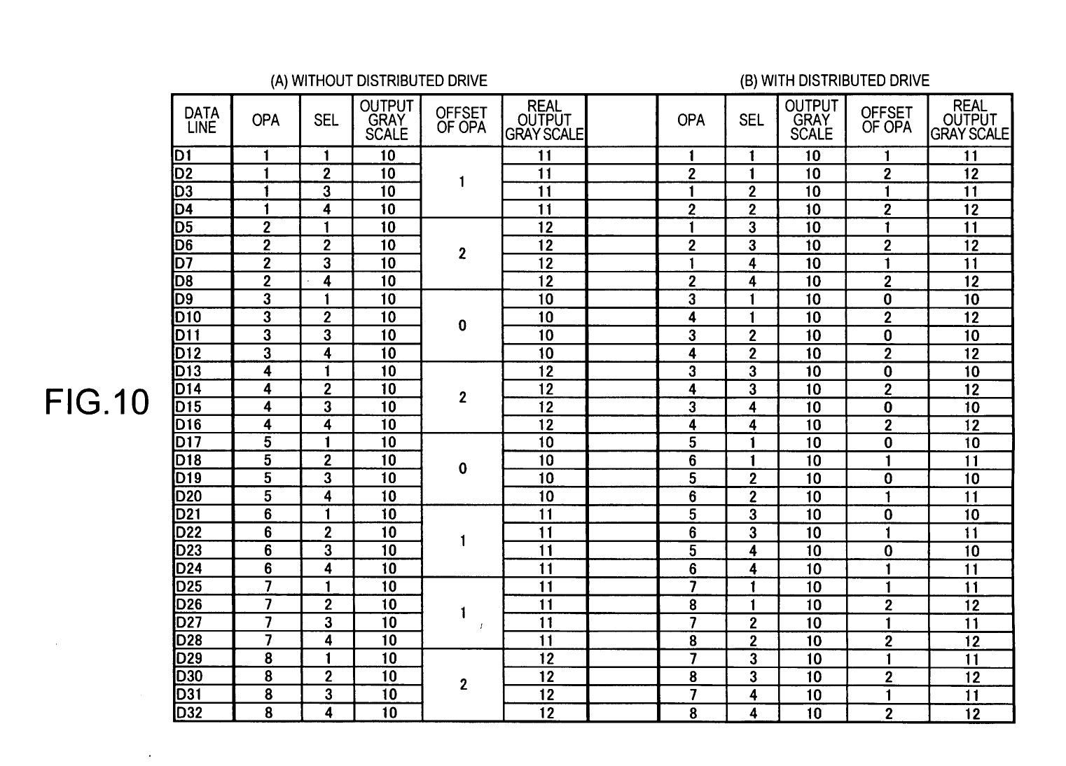

With reference to FIGS. 10(A) and 10(B), the distributed drive will be described more specifically. FIG. 10(A) illustrates an operation example of the normal multiplex drive. As illustrated in FIG. 10(A), it is assumed here that gray-scale voltages in 10 gray scales are output to the data lines D1 to D32. The offset voltages of the operational amplifiers are represented by the gray scales corresponding to the voltages (for example, OPA1 is one gray scale). The gray scales (which are actual output gray scales) corresponding to the output voltages are resulted from the addition of 10 gray scales and the gray scales corresponding to the offset voltages.

As illustrated in FIG. 10(A), 11 gray scales are output to the data lines D1 to D4, and 12 gray scales are output to the data lines D5 to D8, for example. In other words, even the gray-scale voltages output for the same gray scale have a difference in brightness corresponding to one or two gray scales every four data lines as a result. This may be possibly recognized as display unevenness (such as stripes) on a screen.

FIG. 10(B) illustrates an operation example of multiplex drive that performs distributed drive. The offset voltages and others are the same as those in FIG. 10(A). In FIG. 10(B), 11 gray scales and 12 gray scales alternately appear in the data lines D1 to D8, for example. Since a different brightness corresponding to one gray scale appears for every data line, the differences are visually averaged. As a result, the display unevenness (such as stripes) on a screen can be suppressed.

### 8. Fundamental Configuration Example for Performing Distributed Drive

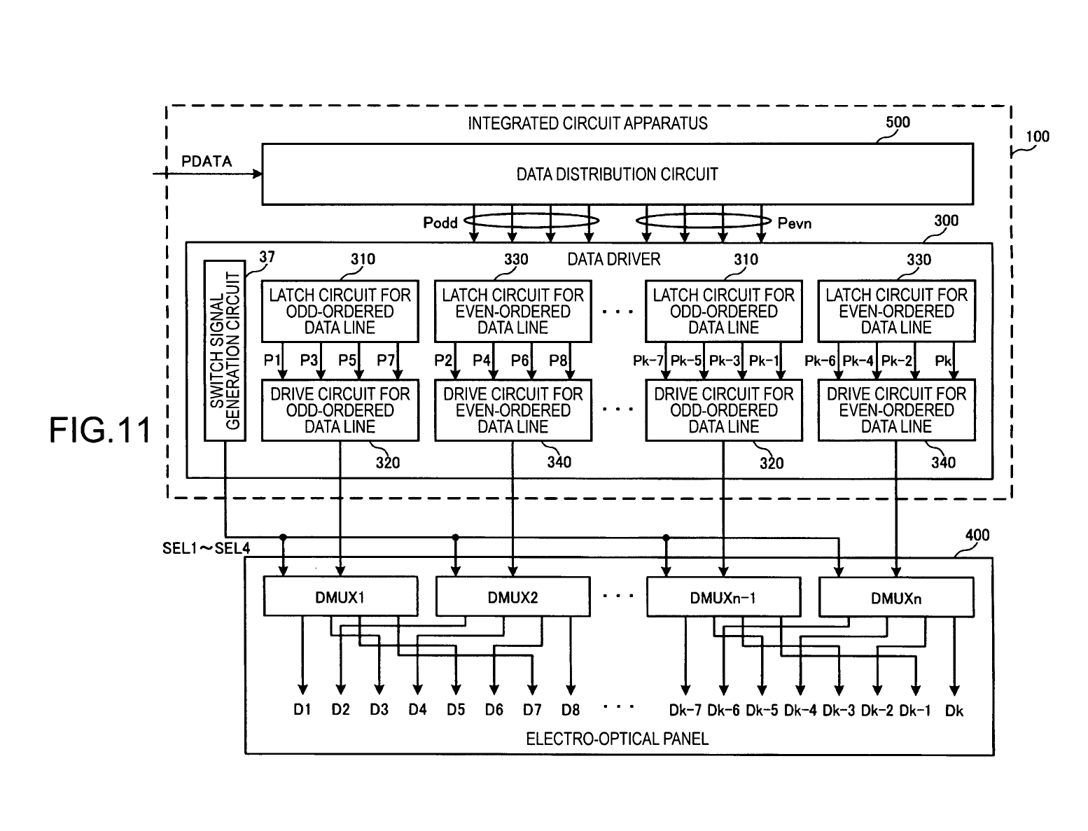

FIG. 11 illustrates a fundamental configuration example of an integrated circuit apparatus that can perform distributed drive. The integrated circuit apparatus 100 (driver) illustrated in FIG. 11 includes a data driver 300 (source driver) and a data distribution circuit 500. The integrated circuit apparatus according to this embodiment is not limited to the configuration in FIG. 11, but different variations can be made thereto including omission of part of components or replacement of part of components by other components.

The data distribution circuit 500 supplies data (such as gray-scale data and image data) to the data driver 300. More specifically, receiving image data PDATA input in a time series manner, the data distribution circuit 500 supplies the equal number of image data Podd for odd-ordered data lines to the number of multiplexing points and the equal number of image data Pevn for even-ordered data lines to the number of multiplexing points. The numbers of the image data Podd for odd-ordered data lines and image data Pevn for even-ordered data lines provided here may not be equal to the number of multiplexing points. For example, they may be higher than the number of multiplexing points.

The data driver 300 drives the first to kth data lines D1 to Dk (a plurality of data lines where k is a natural number) in an electro-optical panel 400 (such as a liquid crystal panel). More specifically, the data driver 300 includes latch circuits 310 for odd-ordered data lines, latch circuits 330 for even-ordered data lines, drive circuits 320 for odd-ordered data lines, drive circuits 340 for even-ordered data lines, and a switch signal generation circuit 37.

The latch circuits 310 for odd-ordered data lines are provided in association with the drive circuits 320 for odd-ordered data lines. The latch circuits 310 for odd-ordered data lines receive image data Podd for odd-ordered data lines from the data distribution circuit 500 and latch data P1, P3, . . . , and Pk-1 corresponding to the odd-ordered data lines D1, D3, . . . , Dk-1 (odd-ordered pixels).

The latch circuits 330 for even-ordered data lines are provided in association with the drive circuits 340 for even-ordered data lines. The latch circuits 330 for even-ordered data lines receive image data Pevn for even-ordered data lines from the data distribution circuit 500 and latch data P2, P4, . . . , and Pk corresponding to even-ordered data lines D2, D4, . . . , and Dk (even-ordered pixels).

The drive circuits 320 for odd-ordered data lines drive odd-ordered data lines of the D1 to Dk. More specifically, the drive circuits 320 for odd-ordered data lines multiplex the equal number of image data for odd-ordered data lines (such as P1, P3, P5, and P7) corresponding to the number of multiplexing points, convert the result to analog signals and supply them to the electro-optical panel 400. The multiplexed data voltages for odd-ordered data lines (data signal for odd-ordered data lines) are demultiplexed by the demultiplexers (such as a DMUX1). The thus acquired demultiplexed data voltages are supplied to the corresponding odd-ordered data lines (such as D1, D3, D5, and D7) in one horizontal scanning period.

In the same manner, the drive circuits 340 for even-ordered data lines drive even-ordered data lines of the D1 to Dk. More specifically, the drive circuits 340 for even-ordered data lines multiplex the equal number of image data for even-ordered data lines (such as P2, P4, P6, and P8) corresponding to the number of multiplexing points, convert the result to analog signals and supply them to the electro-optical panel 400. The multiplexed data voltages for even-ordered data lines (data signal for even-ordered data lines) are demultiplexed by the demultiplexers (such as the DMUX2). The thus acquired demultiplexed data voltages are supplied to the corresponding even-ordered data lines (such as D2, D4, D6, and D8) in one horizontal scanning period.

The switch signal generation circuit 37 controls the demultiplexers DMUX1 to DMUXn. More specifically, the switch signal generation circuit 37 generates multiplex control signal SEL1 to SEL4 for controlling the ON- and OFF-states of a plurality of switching elements for demultiplexing included in the DMUX1 to DMUXn.

### 9. Offset Voltages in Odd-Ordered and Even-Ordered Data Lines

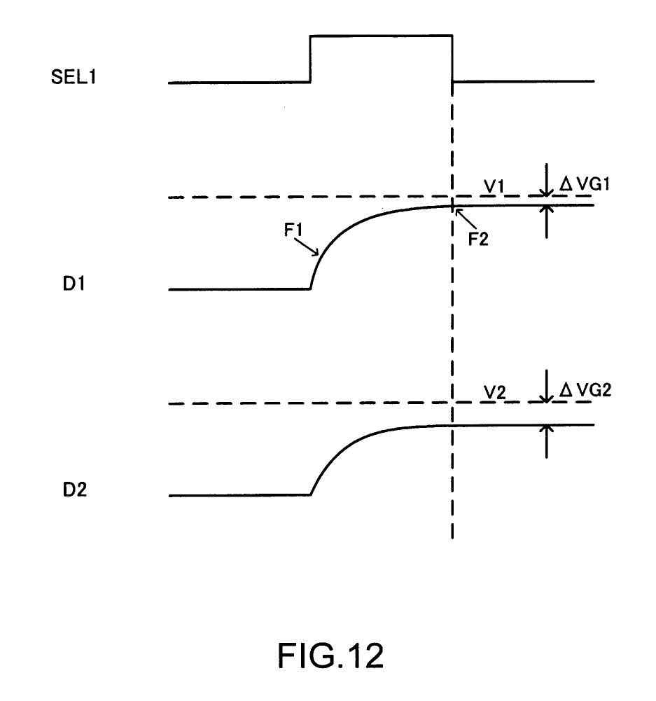

With reference to FIG. 12, position offsets that occur in data voltages for odd-ordered and even-ordered data lines will be described. The odd-ordered data line D1 and even-ordered data line D2, for example, will be described below.

As indicated by F1 in FIG. 12, data voltages are written to the pixels of the D1 and D2 in a period when the SEL1 is active. In this case, the time constant for the writing depends on the load-carrying capacity and/or the like of the data line. It is assumed, for example, that the wire length from an operational amplifier (such as the OPA1 in FIG. 9(B)) to the D1 is shorter than the wire length from another operational amplifier (such as OPA2 in FIG. 9(B)) to the D2. Thus, the time constant for writing to the pixel of the D1 is smaller than the time constant for writing to the pixel of the D2. Therefore, as indicated by F2, the pixel of the D1 is charged more up to a nearly requested voltage V1 than the pixel of the D2. As a result, the data voltages written to the pixels of the D1 and D2 have different voltage position offsets ΔVG1 and ΔVG2 occurring.

As described above, different position offsets may occur in data voltages for the odd-ordered and even-ordered data lines. In this case, if the same position-offset correction is performed on the odd-ordered and even-ordered data lines, offset voltages remain. The remaining offset voltages may possibly cause display unevenness.

### 10. Second Configuration Example

In order to solve the problem, a second configuration example of an integrated circuit apparatus of this embodiment includes first to nth odd-ordered data-line drive circuits 201-1 to 201-n, first to nth offset adding circuits 211-1 to 211-n for odd-ordered pixels, first to nth output selecting circuits 221-1 to 221-n for odd-ordered pixels, an offset register 231 for odd-ordered pixels, a selecting circuit 241 for odd-ordered pixels, first to nth even-ordered data-line drive circuits 202-1 to 202-n, first to nth offset adding circuits 212-1 to 212-n for even-ordered pixels, first to nth output selecting circuits 222-1 to 222-n for even-ordered pixels, an offset register 232 for even-ordered pixels, a selecting circuit 242 for odd-ordered pixels, a sequence setting circuit 250, and a data distribution circuit 500.

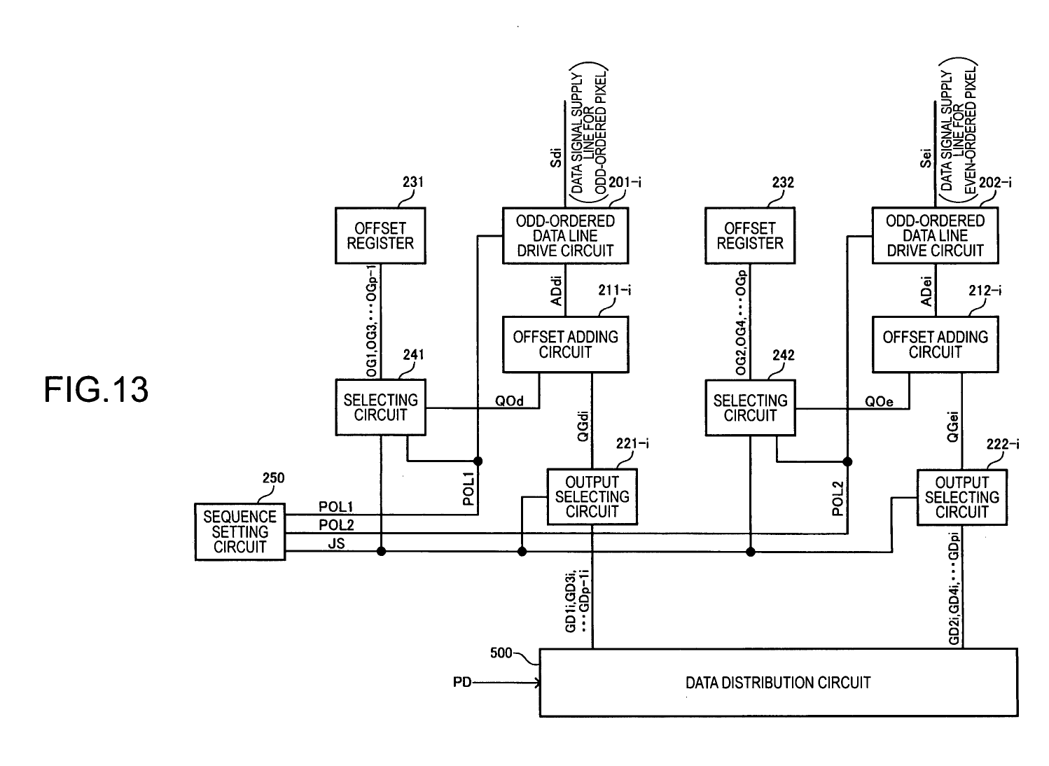

FIG. 13 illustrates the ith data-line drive circuits 201-i and 202-i, offset adding circuits 211-i and 212-i, and output selecting circuits 221-i and 222-i, and these illustrated components will be described below, for example. However, the same is also true in other data-line drive circuits, offset adding circuits, and output selecting circuits.

The second configuration example performs multiplex drive with distributed drive. The second configuration example is a circuit for correcting the offset voltages of data voltages on the basis of offset set value for odd-ordered pixels and offset set values for even-ordered pixels to correct the offset voltages that are different between odd-ordered pixels and even-ordered pixels.

The data distribution circuit 500 receives image data PD and outputs image data (gray-scale data) GD1i, GD3i, . . . , and GDp-1i corresponding to odd-ordered pixels and image data GD2i, GD4i, . . . , and GDpi corresponding to even-ordered pixels. For example, the data distribution circuit 500 receives image data streams from the display controller 40 in FIG. 1.

The output selecting circuit 221-i performs time-division multiplexing on the image data GD1i, GD3i, . . . , and GDp-1i on the basis of the JS and outputs the image data after the time-division multiplexing as a selected image data QGdi.

The offset register 231 stores offset set values OG1, OG3, . . . , and OGp-1 for odd-ordered pixels. The OG1, OG3, . . . , and OGp-1 are set values corresponding to the offset voltages occurring in the data voltages to be written to odd-ordered pixels.

The selecting circuit 241 receives the JS, selects the offset set value corresponding to the pixel instructed by the JS from the OG1, OG3, . . . , and OGp-1 and outputs the selected offset set value as a selected offset set value QOd.

The offset adding circuit 211-i performs processing of correcting an offset voltage occurring in a data voltage to be supplied to an odd-ordered pixel. In other words, the offset adding circuit 211-i acquires an offset correction value ΔOGdi for odd-ordered pixels on the basis of the QOd and QGdi. The offset adding circuit 211-i then adds the QGdi and the ΔOGdi and outputs the image data after the addition as an offset-added data ADdi for the odd-ordered pixel.

The data-line drive circuit 201-i supplies a data voltage to the odd-ordered pixel. More specifically, the data-line drive circuit 201-i receives an ADdi and outputs the time-division multiplexed data voltage corresponding to the ADdi to the data signal supply line Sdi. The time-division multiplexed data voltage is demultiplexed and is supplied to the odd-ordered data line.

Having described the odd-ordered components above, the same is also true in the even-ordered components. In other words, on the basis of the JS, the output selecting circuit 222-i outputs the QGei resulting from the time-division multiplexing on the GD2i, GD4i, . . . , and GDpi. The offset register 232 stores even-ordered offset set values OG2, OG4, . . . , and OGp. On the basis of the JS, the selecting circuit 242 selects one of the OG2, OG4, . . . , and OGp and outputs the QOe. On the basis of the QOe and QGei, the offset adding circuit 212-i acquires the offset correction value ΔOGdi for the even-ordered pixel. The offset adding circuit 212-i adds the QGei and the ΔOGdi and outputs the offset-added data ADei for the odd-ordered pixel. The data-line drive circuit 202-i outputs the time-division multiplexed data voltage corresponding to the ADei to the Sei.

Here, as described above, multiplex drive with distributed drive has the problem that different offset voltages occur between data voltages to odd-ordered and even-ordered data lines and may possibly cause display unevenness.

According to this embodiment, the offset register 231 for odd-ordered pixels store offset set values for odd-ordered pixels. The offset register 232 for even-ordered pixels store offset set values for even-ordered pixels. The drive circuit 201-i for the odd-ordered data line supplies the data voltage corrected on the basis of the offset set value for the odd-ordered pixel to the odd-ordered pixel. The drive circuit 202-i for the even-ordered data line supplies the data voltage corrected on the basis of the offset set value for the even-ordered pixel to the even-ordered pixel.

According to this embodiment, even when data voltages for odd-ordered and even-ordered data lines have different offset voltages, the offset voltages can be corrected on the basis of the offset set values for odd-ordered and even-ordered pixels. Thus, display unevenness can be prevented, and the image quality can be improved.

According to this embodiment, the offset register 231 for odd-ordered pixels may store offset set values for odd-ordered pixels for the positive polarity and negative polarity. The offset register 232 for even-ordered pixels may store offset set values for even-ordered pixels for the positive polarity and negative polarity. The drive circuit 201-i for the odd-ordered data line in a positive drive period and a negative drive period, outputs the data voltages resulting from the correction based on the offset set values for odd-ordered pixels for the positive polarity and negative polarity. The drive circuit 202-i for the even-ordered data line in a positive drive period and a negative drive period outputs the data voltages resulting from the correction based on the offset set values for even-ordered pixels for the positive polarity and negative polarity.

Thus, even when offset voltages occurring in data voltages for odd-ordered and even-ordered data lines are different between positive drive periods and negative drive periods, the offset voltages can be corrected.

### 11. Data Distribution Circuit

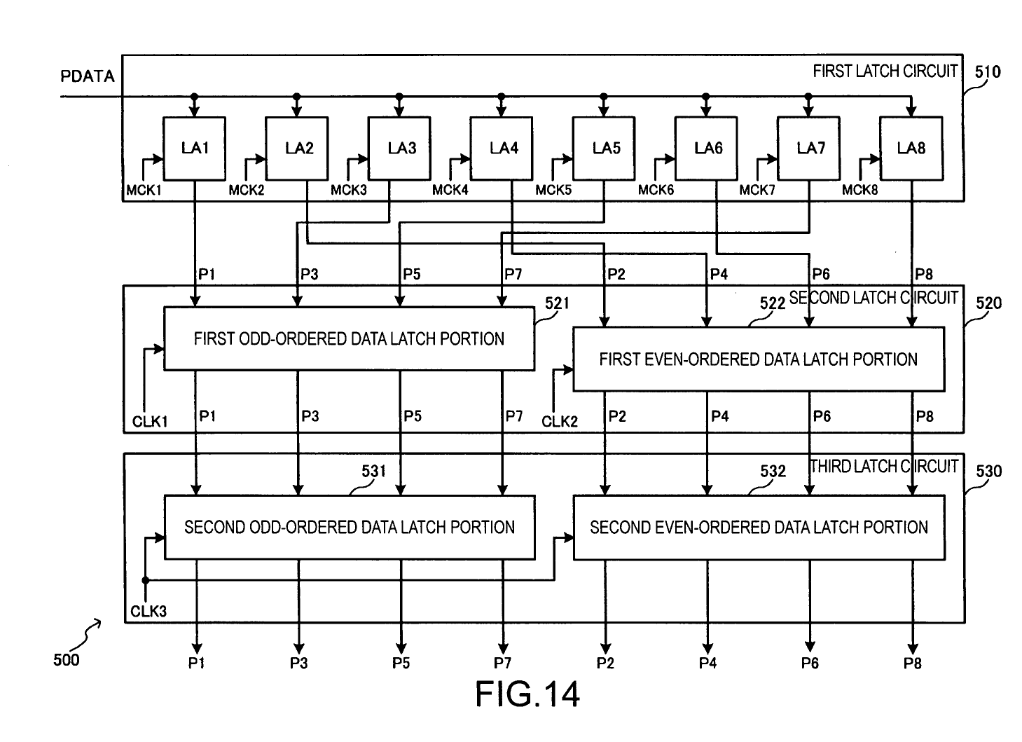

FIG. 14 illustrates a detail configuration example of a data distribution circuit. A data distribution circuit 500 in the configuration example includes first, second and third latch circuits 510, 520 and 530. For convenience of description, FIG. 14 illustrates a case where the number of multiplexing points is 4, the number of distribution points (the number of drive circuits for distributed drive, such as 2 corresponding to the number of operational amplifiers in FIG. 9(B)) is 2. However, the invention is not limited thereto.

The first latch circuit 510 latches image data PDATA input in a time series manner to latch portions LA1 to LA8 on the basis of multi-phase clocks MCK1 to MCK8. The first latch circuit 510 then outputs the image data P1 to P8 latched to the LA1 to LA8.

The second latch circuit 520 has a first odd-ordered data latch portion 521 and a first even-ordered data latch portion 522. The first odd-ordered data latch portion 521 latches image data P1, P3, P5, and P7 for odd-ordered data lines of image data P1 to P8 on the basis of the first clock CLK1. The first even-ordered data latch portion 522 latches the image data P2, P4, P6, and P8 for even-ordered data lines of the image data P1 to P8 on the basis of the second clock CLK2.

The third latch circuit 530 includes a second odd-ordered data latch portion 531 and a second even-ordered data latch portion 532. The second odd-ordered data latch portion 531 latches the data P1, P3, P5 and P7 from the first odd-ordered data latch portion 521 on the basis of the third clock CLK3. The second even-ordered data latch portion 532 latches the data P2, P4, P6, and P8 from the first even-ordered data latch portion 522 on the basis of the third clock CLK3.

FIG. 14 illustrates the image data P1 to P8, for example. However, the same is true in the image data P9, P10 and so on following the P8. Every period of the CLK3, image data Pk-7, Pk-5, Pk-3, and Pk-1 (where k is a multiple of 8) for odd-ordered data lines and image data Pk-6, Pk-4, Pk-2, and Pk for even-ordered data lines are output.

### 12. Data Driver

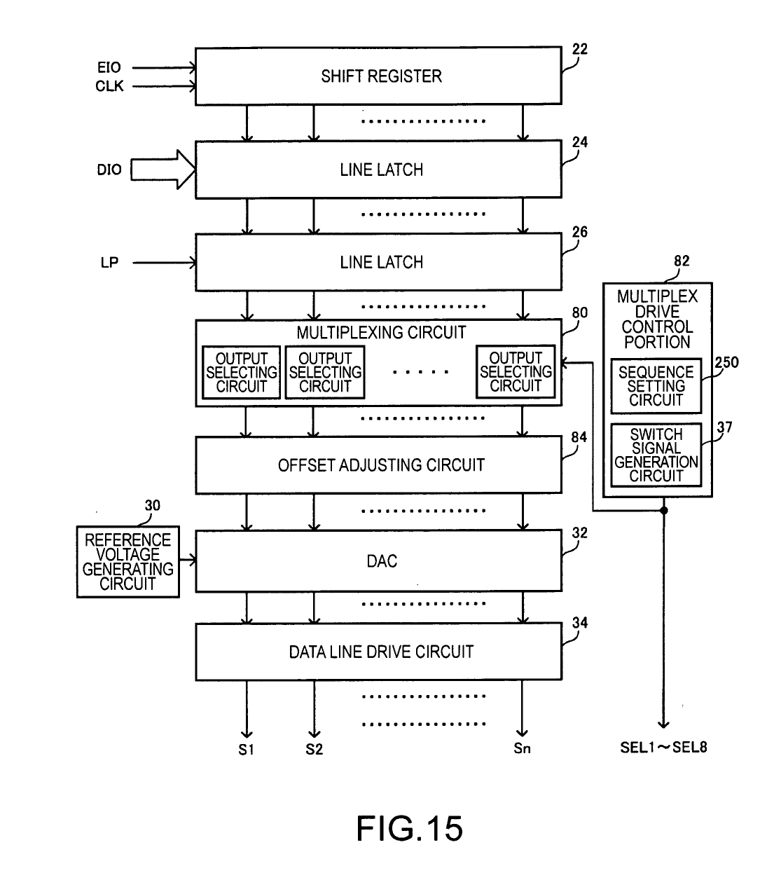

FIG. 15 illustrates a detail configuration example of a data driver. The data driver includes a shift register 22, line latches 24 and 26, a multiplexing circuit 80, an offset adjusting portion 84 (correction circuit), a reference voltage generating circuit 30 (gray-scale voltage generating circuit), a DAC 32 (digital-to-analog converter), a data-line drive circuit 34, and a multiplex drive control portion 82.

The shift register 22 is provided in association with a data line and includes a plurality of sequentially connected flip-flops. In synchronism with a clock signal CLK, an enable input/output signal EIO is sequentially shifted to a neighboring flip-flop. The line latch 24 receives image data DIO (gray-scale data). The line latch latches the DIO in synchronism with the EIO. In synchronism with a horizontal synchronizing signal LP, the line latch 26 latches image data for one horizontal scanning unit that are latched by the line latch 24. The CLK, EIO, DIO, and LP may be input from the display controller 40, for example. When a data distribution circuit is applied to this embodiment, an output from the data distribution circuit is converted to a data stream before the data is input to the line latch 24 as the DIO. Alternatively, the latch circuits in the data distribution circuit may be associated with the line latches 24 and 26.

The multiplex drive control portion 82 generates multiplex control signals SEL1 to SEL8 defining timings for time divisions on data voltages. More specifically, the multiplex drive control portion 82 includes a switch signal generation circuit 37 and a sequence setting circuit 250. The switch signal generation circuit 37 generates the SEL1 to SEL8 and supplies them to a demultiplexer. The sequence setting circuit 250 sets the sequence for activating the SEL1 to SEL8.

The multiplexing circuit 80 performs time-division multiplexing on image data from the line latch 26. More specifically, the multiplexing circuit 80 includes output selecting circuits in association with data signal supply lines. On the basis of the SEL1 to SEL8, the output selecting circuits generate time-division-multiplexed image data corresponding to the data signal supply lines.

The offset adjusting portion 84 performs processing of correcting data voltages. The offset adjusting portion 84 may include the offset register, selecting circuit and offset adding circuit, not illustrated, described with reference to FIG. 7 and so on.

The DAC 32 generates analog gray-scale voltages to be supplied to data lines on the basis of digital image data. More specifically, the DAC 32 receives time-division multiplexed image data from the multiplexing circuit 80 and a plurality of reference voltages (gray-scale voltages) from the reference voltage generating circuit 30 and thus generates time-division multiplexed gray-scale voltages corresponding to the time-division multiplexed image data.

The data-line drive circuit 34 buffers (in a broad sense, impedance-converts) the gray-scale voltages from the DAC 32 and outputs the data voltages to the data signal supply lines S1 to Sn. For example, the data-line drive circuit 34 uses operational amplifiers provided in association with the data signal supply lines and connected in a voltage-follower configuration, not illustrated, to buffer the gray-scale voltages.

### 13. Electronic Equipment

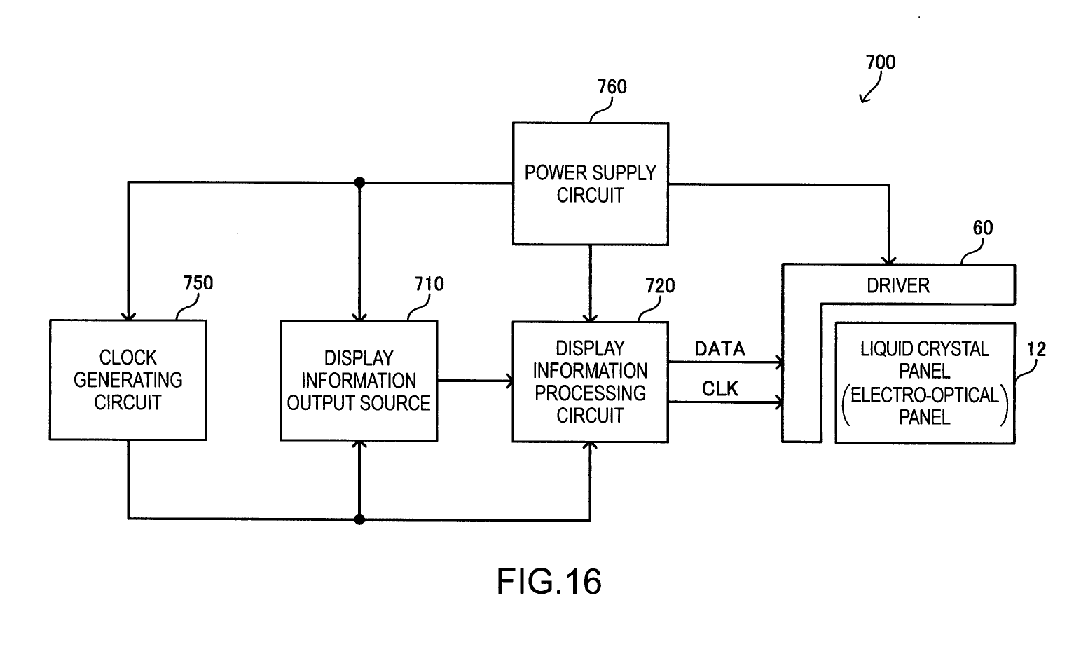

FIG. 16 illustrates a configuration example of a projector (projection display) applying an integrated circuit apparatus of this embodiment. Notably, the electronic equipment applying an integrated circuit apparatus of this embodiment may be a television, a car navigation system, a cellular phone terminal, a portable information terminal, a personal computer or the like instead.

A projector 700 includes a display information output source 710, a display information processing circuit 720, a driver 60 (display driver), a liquid crystal panel 12 (in a broad sense, electro-optical panel), a clock generating circuit 750, and a power supply circuit 760.

The display information output source 710 includes a memory such as a ROM (read only memory), a RAM (random access memory) and an optical disk device and a tuning circuit that tunes and outputs image signals. On the basis of a clock signal from the clock generating circuit 750, the display information output source 710 outputs display information such as image signals in a predetermined format to the display information processing circuit 720. The display information processing circuit 720 may include an amplifier and polarity reversal circuit, a phase expansion circuit, a rotation circuit, a gamma-correction circuit or a clamping circuit, for example. The driver 60 includes a scan driver (gate driver) and a data driver (source driver) and drives the liquid crystal panel 12 (electro-optical panel). The power supply circuit 760 supplies power to those circuits.

Having described this embodiment in detail above, those skilled in the art will easily understand that many variations are possible without substantially departing from the novel matters and effects of the invention. Thus, such variation examples are all included in the scope of the invention. For example, the terms (such as data voltage, liquid crystal display device, liquid crystal panel, and driver) used at least once herein or in the appended drawings together with different terms (such as data signal, electro-optical apparatus, electro-optical panel, and integrated circuit apparatus) which are synonymous in a broad sense or synonymous may be replaced by different terms in any part hereof or the accompanying drawings. The configurations and operations of the offset register, offset adding circuits, integrated circuit apparatus, electro-optical apparatus, electronic equipment and so on are not limited to those described according to the embodiment, but different variations are possible.

What is claimed is:

1. An integrated circuit apparatus comprising:
data-line drive circuits that are provided in association with a plurality of data signal supply lines and each of which supplies a multiplexed data signal to the corresponding data signal supply line of the plurality of data signal supply lines;
an offset register that stores offset set values corresponding to offsets occurring in a plurality of demultiplexed data signals resulting from demultiplexing by a demultiplexer on the multiplexed data signal when the plurality of data signals are supplied to a plurality of pixels in one horizontal scanning period; and
correction circuits that are provided in association with the data-line drive circuits and perform processing of correcting the offsets on the basis of the offset set values,
wherein the offset register
stores offset set values for the positive polarity and offset set values for the negative polarity as the offset set values; and
the data-line drive circuits
supply data signals resulting from correction based on the offset set values for the positive polarity to the data signal supply lines in a positive drive period; and
supply data signals resulting from correction based on the offset set values for the negative polarity to the data signal supply lines in a negative drive period.

2. The integrated circuit apparatus according to claim 1, wherein:
the data-line drive circuits include
drive circuits for odd-ordered data lines that supply data signals to data signal supply lines for odd-ordered pixels of the plurality of pixels; and
drive circuits for even-ordered data lines that supply data signals to data signal supply lines for even-ordered pixels of the plurality of pixels; and
the offset register includes
an offset register for odd-ordered pixels that stores an offset set value for odd-ordered pixels corresponding to an offset occurring in data signals to be supplied to the odd-ordered pixels; and
an offset register for even-ordered pixels that stores an offset set value for even-ordered pixels corresponding to an offset occurring in data signals to be supplied to the even-ordered pixels.

3. The integrated circuit apparatus according to claim 2, wherein:
the offset register for odd-ordered pixels
stores an offset set value for odd-ordered pixels for the positive polarity and an offset set value for odd-ordered pixels for the negative polarity as the offset set value for odd-ordered pixels; and
the offset register for even-ordered pixels
stores an offset set value for even-ordered pixels for the positive polarity and an offset set value for even-ordered pixels for the negative polarity as the offset set value for even-ordered pixels; and
the drive circuits for odd-ordered data lines
supply the data signals resulting from the correction based on the offset set value for odd-ordered pixels for the positive polarity to the data signal supply lines for odd-ordered pixels in a positive drive period; and
supply the data signals resulting from the correction based on the offset set value for odd-ordered pixels for the negative polarity to the data signal supply lines for odd-ordered pixels in a negative drive period; and
the drive circuits for even-ordered data lines
supply the data signals resulting from the correction based on the offset set value for even-ordered pixels for the positive polarity to the data signal supply lines for even-ordered pixels in a positive drive period; and
supply the data signals resulting from the correction based on the offset set value for even-ordered pixels for the negative polarity to the data signal supply lines for even-ordered pixels in a negative drive period.

4. The integrated circuit apparatus according to claim 2, further comprising a data distribution circuit that supplies data to the data-line drive circuits, wherein:
the data-line drive circuits have
latch circuits for odd-ordered data lines provided in association with the drive circuits for odd-ordered data lines; and
latch circuits for even-ordered data lines provided in association with the drive circuits for even-ordered data lines; and
the data distribution circuit
receives image data input in a time series manner, supplies the equal number of image data for odd-ordered data lines to the number of multiplexing points to the latch circuits for odd-ordered data lines and supplies the equal number of image data for even-ordered data lines to the number of multiplexing points to the latch circuits for even-ordered data lines.

5. The integrated circuit apparatus according to claim 1,
wherein the offset registers at least store, as the offset set values,
a first offset set value corresponding to the first pixel of the first to pth (where p is an integer that is equal to or greater than two) pixels of the plurality of pixels and a pth offset set value corresponding to the pth pixel of the first to pth pixels; and
the correction circuit at least performs, as the processing of correcting the offsets,
processing of adding an offset correction value based on the first offset set value to the first image data of the first to pth image data corresponding to the first to pth pixels and processing of adding an offset correction value based on the pth offset set value to the pth image data of the first to pth image data.

6. The integrated circuit apparatus according to claim 5, wherein
the offset register stores
the second to (p−1)th offset set values corresponding to the second to (p−1)th pixels of the first to pth pixels; and
the correction circuit
performs processing of adding offset correction values based on the second to (p−1)th offset set values to the second to (p−1)th image data of the first to pth image data.

7. The integrated circuit apparatus according to claim 1, further comprising a switch signal generation circuit that generates demultiplexing switch signals for controlling the ON- and OFF-states of a plurality of demultiplexing switching elements included in the demultiplexer.

8. An electro-optical apparatus comprising the integrated circuit apparatus according to claim 1.

9. Electronic equipment comprising the electro-optical apparatus according to claim 8.
